(19) United States
(12) Patent Application Publication
(10) Pub. No.: US 2026/0230540 A1
(43) Pub. Date: Aug. 6, 2026

(54) CONVERSION DEVICE AND CONVERSION METHOD FOR COMMUNICATION PROTOCOL FORMAT OF SENSOR

(71) Applicant: Brillian Network & Automation Integrated System Co., Ltd., Miaoli County (TW)

(72) Inventors: YU-SHENG LIU, Miaoli County (TW); CHIH-YI WANG, Miaoli County (TW)

(21) Appl. No.: 19/198,139

(22) Filed: May 5, 2025

(30) Foreign Application Priority Data
Feb. 4, 2025 (TW) 114103921

(51) Int. Cl. H04L 67/56; H04L 67/141; H04L 67/51

(52) U.S. Cl. CPC H04L 67/56; H04L 67/141; H04L 67/51

(57) ABSTRACT

A method is introduced for producing solid state disks (SSDs), which is performed by a processing unit of a production host. The production host includes a device interface including first ports. Each first port is connected to one hub. Each hub includes second ports. The method includes the steps of: loading a port-mapping configuration table containing location information for indicating the second ports; comparing location information of a hardware description file with the location information of the port-mapping configuration table to determine whether each second port is connected to a SSD; displaying a graphical user interface (GUI) for showing whether each second port is connected to a SSD; and, when a SSD connecting to one second port fails to perform a card-activation process, updating the GUI for showing information about a card-activation failure has occurred in the SSD connecting to the corresponding second port. With the aforementioned comparisons therebetween, it can automatically identify ports of each hub of the production system.

### TECHNICAL FIELD

The present invention relates to a storage device, in particular a computer program product and method for producing solid-state drives and a device.

### PRIOR TECHNOLOGY

SSDs usually need to complete the card opening process before they can be shipped from the factory, and the time spent on the card opening process is an important issue in the production of solid state drives. A production host typically connects 5 to 16 SSDs through the ports of the device interface, and the connected SSDs are carded. However, traditionally, when one of the SSDs fails to open the card, the production host cannot automatically know which one actually made the error, requiring the production personnel to manually unplug the connected solid-state drive for confirmation, which prolongs the production time. Therefore, the present invention proposes a method, device, and computer program product for producing solid-state drives to solve the problems described above.

### INVENTION CONTENT

In view of this, how to mitigate or eliminate the deficiencies in the above related areas is indeed a problem to be solved.

This specification relates to an embodiment of a method for producing a solid state drive, performed by the processing unit of the production host. The production host contains the device interface, and the device interface contains multiple first ports. Each first port connects to a hub, and each hub contains multiple second ports. The above methods include: loading the port map configuration table, which contains the location information representing each second port; Compare the location information in the hardware profile with the location information in the port map configuration table to determine whether each second port is connected to the SSD; displays a graphical user interface on the display that indicates whether each second port is connected to the solid state drive; and when one of the connected SSDs in the second port fails to boot, the graphical user interface is updated to indicate that the activation failure occurred on the solid-state drives connected to the corresponding second port.

This manual also deals with a computer program product that contains code for the production of solid-state drives. When the processing unit of the production host executes the code, the method of production SSD as described above is implemented.

This manual also relates to a device for the production of solid-state drives, including the above device interface and processing unit. Handle the unit coupled device interface to implement the method described above when loading and executing the code described above.

One of the advantages of the above embodiment is that each port on each hub in the production system can be automatically identified whether the solid state drive is connected or not through the comparison described above.

Another advantage of the above embodiment is that through the information contained in the port mapping configuration table described above, when a solid state drive fails to boot, it can automatically identify which port the solid state drive connected to occurred during the card opening process.

Other advantages of the present invention will be explained in more detail with the following descriptions and diagrams.

### IMPLEMENTATION METHOD

The following description is a better way to complete the invention and is intended to describe the basic spirit of the invention, but is not intended to qualify the invention. The actual content of the invention must refer to the scope of the claims below.

It is important to understand that the words “include”, “include” and “include” are used in this manual to indicate the presence of specific technical characteristics, values, method steps, operations, components, and/or components, but does not exclude the addition of additional technical characteristics, values, method steps, operations, components, components, or any combination of the above.

The use of words such as “first”, “second”, “third” in claims is used to modify components in claims, not to indicate that there is a priority, precedent relationship between components, or that one component precedes another, or that the chronological order in which method steps are executed, and is only used to distinguish components with the same name.

It is important to understand that when a component is described as “connected” or “coupled” to another component, it can be directly linked or coupled to another component, and intermediate components may occur. Conversely, when a component is described as “directly connected” or “directly coupled” to another component, there are no intermediate components in it. Other words used to describe the relationship between components can be interpreted in a similar way, such as “in” versus “directly in”, or “adjacent” versus “direct adjacent”, etc.

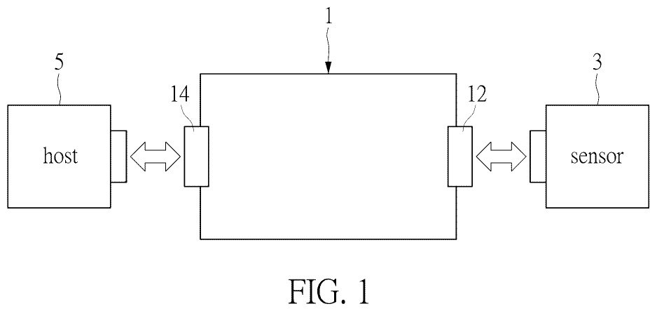

In order to enable the production computer to automatically distinguish between solid state disks (SSDs) connected on each port, the embodiment of the present invention divides the entire production process into two stages: the port distinguishing stage and the card activation stage. Referring to FIG. 1, in the fixed port phase 110, the training computer 140 analyzes the contents of the hardware description file in the operating system (OS) and is used to obtain the identification information of each physical port, such as the Serial Advanced Technology Attachment/Fast Peripheral Device Interconnection Registry (SATA/Peripheral Component Interconnect Express, PCIe Registries), Bus Number, Target ID, Logical Unit Number (LUN), etc., and generate a Port-mapping Configuration Table (Port-mapping Configuration Table) 160 accordingly. During the activation phase 130, the production computer 180 loads the port mapping configuration table 160 and performs the card opening procedure for multiple solid-state drives connected to the production computer 180. During the card opening process, if the production computer 180 finds any error message, it can identify which physical port the solid-state drive connected to the solid state drive has an error based on the information in the port mapping configuration table 160 and display it on the graphical user interface (GUI), which is convenient for the operator and/or the production machine 180 to perform error troubleshooting processing. It is important to note here that the training computer 140 and the production computer 180 can be two computers with the same necessary software and hardware configuration, or the same computer.

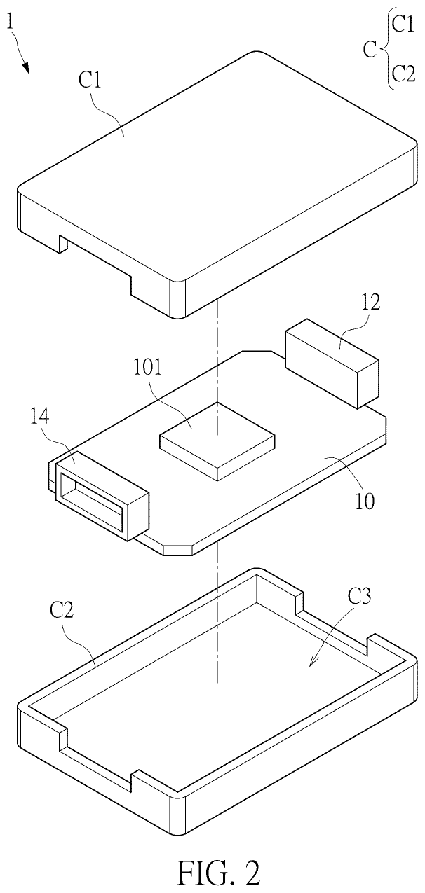

Refer to FIG. 2. The training system 20 includes a port-distinguishing host 210, a hub 230, a training solid state drive 250, and a monitor 270. The training computer 140 described in FIG. 1 may comprise a fixed port host 210, a hub 230, and a display 270. The training SSD 250 can include a flash controller and multiple flash modules. The display 270 can be a thin film transistor-liquid crystal display (TFT-LCD display), organic light-emitting diode display (OLED display), etc., which displays a screen that engineers or operators can watch during the training process, including text, numbers, symbols, patterns, etc., or any combination of the above.

The fixed port host 210 can be implemented on personal computers, laptop PCs, industrial computers, workstations, etc. The fixed port host 210 comprises a device interface 212 with multiple ports 214-1 to 214-4, each of which can be connected to a hub, for example, port 214-1 is connected to a hub 230. Although the device interface 212 described in FIG. 2 is only equipped with four ports, the person in the technical field may be equipped with more or fewer ports on the device interface 212, so that the fixed-port host 210 can connect to more or fewer hubs, and the present invention should not be restricted by this. The hub 230 contains multiple ports 232-1 to 232-4, each of which can be plugged into a training SSD 250, such as any of the training SSDs 250-1 to 250-4. It should be noted that for the sake of brevity of the instructions, when the following paragraphs are described using the training SSD 250, it means that the structure, functions, method steps, or other technical content described can be applied to the training SSD 250-1 to 250-4 and any of the others. Although the hub 230 described in FIG. 1 has 4 ports, the person in the technical field can connect a hub with more or fewer ports to the fixed port host 210, so that the fixed port host 210 can connect more or fewer training solid state drives, and the present invention should not be restricted by this.

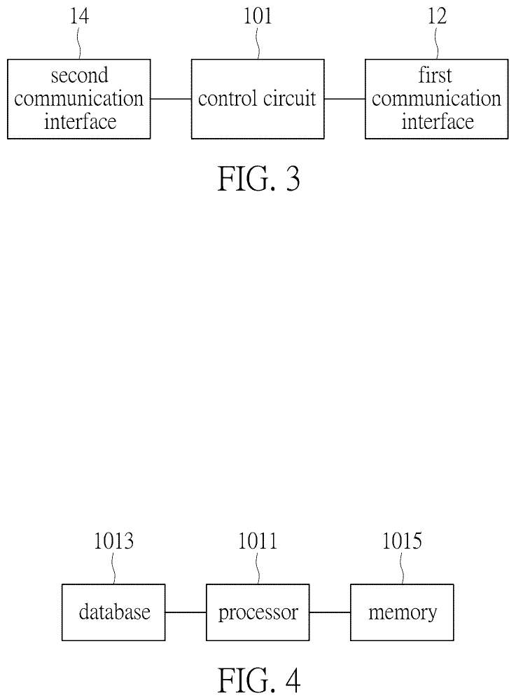

Refer to FIG. 3. Since the hub 230 connects to a port on the device interface 212 and when the training SSD 250 is plugged into the hub 230, it is equivalent to training the SSD 250 physically connecting to the fixed port host 210, so the hub 230 shown in FIG. 2 is omitted in FIG. 3. The fixed port host 210 includes a processing unit 312, which can be implemented in a variety of ways, such as using general-purpose hardware (e.g., a single processor, a multi-processor with parallel processing capabilities, a graphics processor, or other processors with computing power), and when executing software and/or firmware instructions, for example, a port-distinguishing tool, an operating system (OS), a driver, etc., Provide specified functions. The processing unit 312 can send commands to the training SSD 250 through the device interface 212 to complete the required operations.

The training SSD 250 includes a flash memory controller 330 and a flash memory module 350. The Flash Module 350 provides a large amount of storage space, usually hundreds of gigabytes or even several megabytes, for storing large amounts of user data, such as high-resolution images, videos, etc. The flash memory controller 130 comprises a host interface 332, and the host interface 332 is coupled to the device interface 212 of the fixed-port host 210.

In order to distinguish ports 214-1 to 214-4 of the device interface 212 as shown in FIG. 2 and ports 232-1 to 232-4 of the hub 230, it is necessary to provide a hardware profile to identify ports 214-1 to 214-4 and ports 232-1 to 232-4, so that the software program can know when running an output input device is connected to the fixed port host 210 through one of the ports 214-1 to 214-4 and ports 232-1 to 232-4. For example, Windows Registry is a hierarchical database that stores underlying settings and is used by Windows operating systems (Windows OS) and applications. In detail, the window registry contains information, settings, options, and other values for the hardware (such as SATA/PCIe interfaces, etc.) of the fixed port host 210 and the devices connected to the fixed port host 210 (such as solid state drives). When a solid state drive is connected to the host 210 on the fixed port through a port of the hub 230, a new subkey is added to the window registry file, which contains multiple values (Values) to store settings such as hardware identifiers, location information, manufacturers, services, etc.

An embodiment of the present invention proposes a port fixation method, which is implemented when the processing unit 312 loads and executes the code of the port fixation tool. Refer to FIG. 4. Taking Windows operating system as an example, the details are as follows:

Step S410: Set the variable i=1. Variable i is used to record the order number of the fixed port.

The process then repeats a loop with steps S420 through S480. Before each round runs, the operator inserts a training SSD into the designated port. For example, port 232-1, port 232-2, port 232-3, and port 232-4 of hub 230 can be labeled as Port #1, Port #2, Port #3, and Port #4, in that order. After the operator inserts the training SSD 250-1 into port 232-1, the processing unit 312 performs steps S420 through S480 to determine the port of port #1. The operator then inserts the training SSD 250-2 into port 232-2, and the processing unit 312 performs steps S420 to S480 to fix port #2. This process repeats until the required ports are determined.

Step S420: Obtain the Subkey added to the window registry corresponding to the newly inserted SSD. For example, processing unit 312 can run the Microsoft Application Programming Interface (API) function “CreateFile” to obtain the handle code for the path “Enum\SCSI” in the window registry. Then, the processing unit 312 can run the Microsoft API function “DeviceIOControl” to check whether there are any newly added subkeys in the acquired control code. If there is a newly added subkey, it means that a newly added Small Computer System Interface (SCSI) device is detected, and the class globally unique identifier (ClassGUID) of this subkey is obtained. If there is no newly added subkey, Processing Unit 312 can execute the Microsoft API function “CreateFile” to obtain the handle code for the path “Enum\IDE” in the window registry. Then, the processing unit 312 can run the Microsoft API function “DeviceIOControl” to check whether there are any newly added subkeys in the acquired handle. If there is a newly added subkey that represents the detection of a newly added Integrated Drive Electronics (IDE) device, obtain a class globally unique identifier for this subkey.

Step S430: Get the location information of the ith port from the newly added subkey. For example, processing unit 312 can run the Microsoft API function “WINSETUPAPI SetupDiGetClassDevs”, which is used to obtain the handle “HDEVINFO” pointing to a specific Device Information Set based on the class global unique identifier (obtained in step S420). The processing unit 312 can run the Microsoft API function “WINSETUPAPI SetupDiEnumDeviceInterface” for enumerating the device interfaces contained in the handle code “HDEVINFO”, and the data of the device interface can be stored in the default buffer in RAM 314. Processing unit 312 can execute the Microsoft API function “WINSETUPAPI SetupDiGetDeviceInterfaceDetail” to obtain details of the device interface, including the device path and location information. Location information consists of three parts: bus number; Target ID; and Logical Unit Number (LUN). For example, location information can be used to identify one of ports 232-1 to 232-4 of hub 230 in FIG. 2. The processing unit 312 can break the string between the second and third tic-tac-toe (“#”, Hashtag) from the device path, and take out the last character in the string and the character before the symbol (“&”, Ampersand) as the device path serial number. For example, the processing unit 312 can retrieve the device path serial number “4&2e835db4&0” from the device path “\\?\scsi#disk&ven_wdcΠ_wd10spzx-08z10#4&2e835db4&0&000200#{53f56307-b6 bf-11d0-94f2-00a0c91efb8b}”. For another example, processing unit 312 can retrieve the device path serial number “5&39170d9180” from the device path “\\?\ide#disksmi_disk_q0921b#5&39170d9 1&0&1.0.0#(53f56307-b6bf-11d0-94f2-00a0c91efb8b}”.

Step S440: Obtain the PCI or IDE registry for port ith based on the device path serial number of port i. Processing unit 312 can determine which path the newly added subkey is in based on the information detected in step S420 which path it is to scan which is the PCI or IDE registry.

If the newly added subkey is in the path “Enum\SCSI”, the processing unit 312 scans the PCI registry. For example, processing unit 312 executes the Microsoft API function “CreateFile” to obtain the handle code for the path “Enum\PCI” in the window registry. Processing unit 312 can execute the Microsoft API function “DeviceIOControl” to obtain all subkeys in the handle. Then, for each subkey, referring to the technical content described in step S420, processing unit 312 can execute the Microsoft API functions “WINSETUPAPI SetupDiGetClassDevs”, “WINSETUPAPI SetupDiEnumDeviceInterface” and “WINSETUPAPI SetupDiGetDeviceInterfaceDetail” to obtain the Registry Value “ParentIdPrifix” and compare whether the registry value “ParentIdPrifix” matches the serial number of the device path obtained in step S430. If it matches, it means that this subkey contains the PCI registry of the ith port, and the processing unit S312 can run the Microsoft API function “WINSETUPAPI SetupDiGetDeviceInterfaceDetail” to obtain the PCI registry. The processing unit 312 can break the string between the second backslash (“\”, Backslash) and the last and symbol (“&”, Ampersand) from the PCI registry as the device path serial number of the PCI device. For example, the processing unit 312 can retrieve the device path serial number “3&11583659&” from the PCI device's device path “PCI\VEN_8086&DEV_9D03&SUBSYS_225D17AA&&REV_21\3&11583659&0&0&B8”.

If the newly added subkey is in the path “Enum \IDE”, the processing unit 312 scans the PCIIDE registry. For example, processing unit 312 executes the Microsoft API function “CreateFile” to obtain the handle code for the path “Enum\PCIIDE” in the window registry. Processing unit 312 can execute the Microsoft API function “DeviceIOControl” to obtain all subkeys in the handle. Then, for each subkey, referring to the technical content described in step S420, processing unit 312 can execute the Microsoft API functions “WINSETUPAPI SetupDiGetClassDevs”, “WINSETUPAPI SetupDIEnumDeviceInterface” and “WINSETUPAPI SetupDiGetDeviceInterfaceDetail” to obtain the registry value “ParentIdPrifix” and compare whether the registry value “ParentIdPrifix” matches the device path serial number obtained in step S430. If it matches, it means that this subkey contains the IDE registry of the ith port, and the processing unit S312 can run the Microsoft API function “WINSETUPAPI SetupDiGetDeviceInterfaceDetail” to get the IDE registry. The processing unit 312 can break the string between the second backslash (“\”, Backslash) and the last and symbol (“&”, Ampersand) from the IDE registry as the device path serial number of the IDE device. For example, the processing unit 312 can retrieve the device path serial number “4&1dd8ffee&0” from the device path “PCIIDE\IDEChannel\4&1dd8ffee&0&0&1” of the IDE device.

Step S450: Obtain the SATA or PCIe registry according to the device path serial number of the PCI or IDE device. For example, processing unit 312 can run the Microsoft API function “CreateFile” to obtain the handle code for the path “Enum\PCI” in the window registry. Processing unit 312 can execute the Microsoft API function “DeviceIOControl” to obtain all subkeys in the handle. Then, for each subkey, referring to the technical content described in step S420, processing unit 312 can execute the Microsoft API functions “WINSETUPAPI SetupDiGetClassDevs”, “WINSETUPAPI SetupDiEnumDeviceInterface” and “WINSETUPAPI SetupDiGetDeviceInterfaceDetail” to obtain the registry value “ParentIdPrifix” and compare whether the registry value “ParentIdPrifix” matches the device path serial number obtained in step S440. If it matches, it means that this subkey contains the SATA registry of the ith port, and the processing unit S312 can run the Microsoft API function “WINSETUPAPI SetupDiGetDeviceInterfaceDetail” to obtain the SATA registry.

If the handle code with the path “Enum\PCI” in the window registry cannot find a matching registry, the processing unit 312 executes the Microsoft API function “CreateFile” to obtain the handle code of the path “Enum\ACPI” in the window registry. Processing unit 312 can execute the Microsoft API function “DeviceIOControl” to obtain all subkeys in the handle. Then, for each subkey, referring to the technical content described in step S420, processing unit 312 can execute the Microsoft API functions “WINSETUPAPI SetupDiGetClassDevs”, “WINSETUPAPI SetupDiEnumDeviceInterface” and “WINSETUPAPI SetupDiGetDeviceInterfaceDetail” to obtain the registry value “ParentIdPrifix” and compare whether the registry value “ParentIdPrifix” matches the device path serial number obtained in step S440. If it matches, it means that this subkey contains the PCIe registry file of the ith port, and the processing unit S312 can run the Microsoft API function “WINSETUPAPI SetupDiGetDeviceInterfaceDetail” to obtain the PCIe registry file, “ACPI\PNP0A08\0”. For example, a SATA or PCIe registry can be used to identify one of ports 214-1 to 214-4 of the device interface 212 in FIG. 2.

Step S460: Save the port fixing information for the ith port to the port map configuration table 160 in RAM 314 and/or Storage Unit 316. The port fixing information includes the location information obtained by step S430 and the SATA or PCIe registry obtained by step S450. Table 1 Some examples of port mapping configuration table 160:

TABLE 1

| | | Target | Logical | |
|---|---|---|---|---|
| | Busbar | identification | unit | SATA/PCIe |
| port | number | code | number | registry |
| Port#1 | 0 | 2 | 0 | ACPI\PNP0A08\0 |
| Port#2 | 0 | 4 | 1 | ACPI\PNP0A08\0 |
| Port#3 | 0 | 6 | 2 | ACPI\PNP0A08\0 |
| Port#4 | 0 | 8 | 3 | ACPI\PNP0A08\0 |

For example, records 1 to 4 of Port Mapping Configuration Table 160 store the location information and PCIe registry of ports from Port #1 to Port #4, respectively.

Step S470: Determine that the negative port operation is complete. If so, the process ends and the port mapping configuration table 160 is complete. Otherwise, the process continues with the processing of step S480.

Step S480: Calculate i=i+1.

When the process is over, the RAM 314 of the fixed port host 210 or the port mapping configuration table 160 in the storage unit 316 can be output to the production computer 180 for reference in the card opening process.

It is important to note here that since the operator inserts all the ports of the training SSD to the hub one by one in the default order, the order of the location information in the port mapping configuration table 160 matches the default physical arrangement of the ports of the hub.

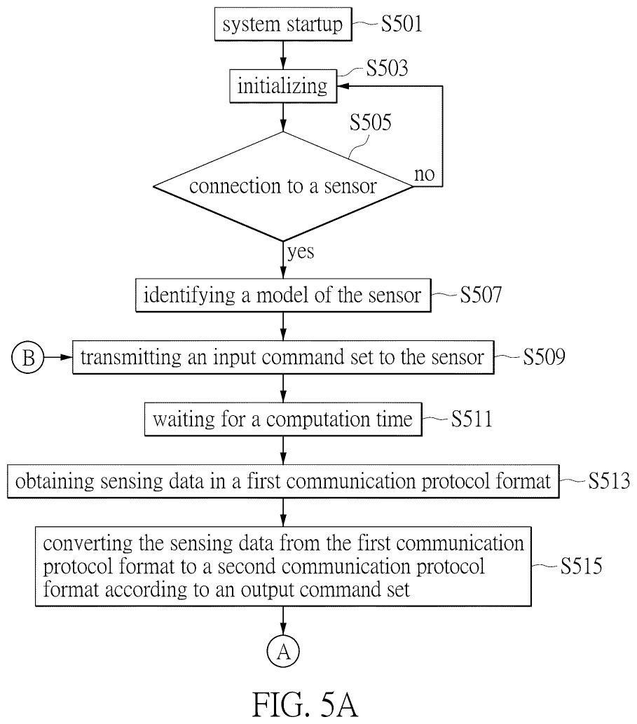

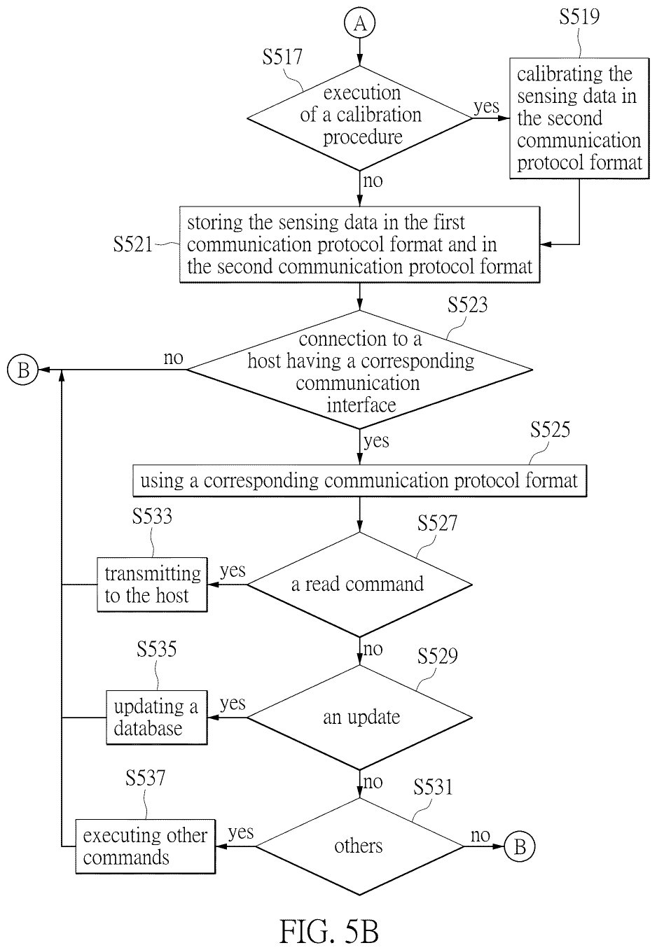

Refer to FIG. 5. The production system 50 includes the Production Host 510, the hub 530, the SSD 550-1 to the 550-4, and the display 570. For each SSD 550, after the flash controller and flash module are installed on the motherboard, the card-activation process needs to be completed before it can be shipped and provided to customers. The display 570 can be a thin-film transistor liquid crystal display, an organic light-emitting diode display, etc., which displays a screen that can be viewed by engineers or operators during the card opening process, including prompt text, numbers, symbols, patterns, etc., or any combination of the above.

Under normal circumstances, the device interface 512 in the production host 510 has the same device interface 212 as the hub 530 or matches the device interface 212 of the fixed-port host 210, and the software and hardware settings of the hub 230. For the sake of brevity of the instructions, when the following paragraphs are described using the SSDs 550s, the structures, functions, method steps, or other technical content they describe can be applied to any of the SSDs 550-1 through 550-4 and others.

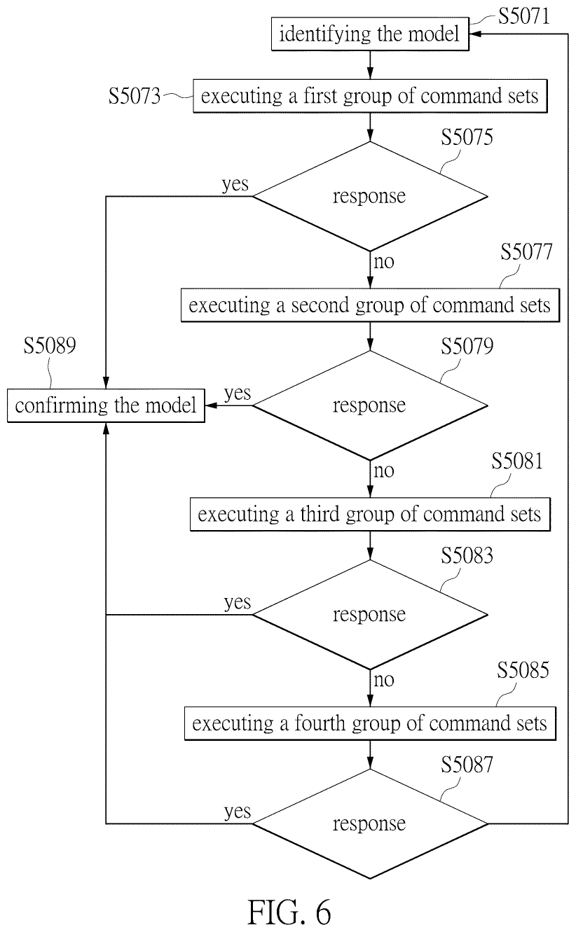

Refer to FIG. 6. Since when the hub 530 connects a port on the device interface 512 and the solid state drive 550 is plugged into the hub 530, it is equivalent to the solid state drive 550 physically connecting to the production host 510, so the hub 530 shown in FIG. 1 is omitted in FIG. 6. The production host 510 includes a processing unit 612, which can be implemented in a variety of ways, such as using general-purpose hardware (e.g., a single processor, a multiprocessor with parallel processing capabilities, a graphics processor, or other processors with computing power), and when executing software and/or firmware instructions, for example, a mass production tool (MP tool), an operating system (OS), a driver, etc., Provide specified functions. The processing unit 612 can issue commands to the device interface 512 to send vendor commands to the solid-state drive 550 to complete the operations required in the card opening process. Vendor commands are not standard host operation commands, such as Universal Flash Storage (UFS), Non-Volatile Memory Express (NVMe), Open-channel Solid State Disk (SSD), etc. Instead, it is the custom commands (Proprietary Commands) provided to customers by the manufacturer of the SSD 550 or Flash Controller 630.

The production host 510 includes a storage unit 616, which can be used for hard disks and solid-state drives to map the storage port configuration table 160. The production host 510 also includes a RAM 614 for temporary data required to execute the card opening process, such as variables, flags, port mapping configuration tables 160, and so on.

The SSD 550 includes a flash controller 630 and a flash module 650. The Flash Module 650 provides a large amount of storage space, usually hundreds of gigabytes or even several megabytes, for storing large amounts of user data, such as high-resolution images, videos, etc. The flash memory module 650 includes a control circuit and a memory array, and the memory cells in the memory array can include single level cells (SLCs), multiple level cells (MLCs), triple level cells (TLCs), quad-level cells (QLCs), or any combination of the above.

The flash memory controller 630 comprises a host interface 632, a flash memory interface 634, a volatile random access memory (VRAM) 636, a processing unit 637, a read-only memory (ROM) 638, and an input/output interface 639. The host interface 632 is coupled to the device interface 512 of the production host 510. The Flash Interface 634 is coupled to the Flash Module 650 and can communicate with each other using Double Data Rate (DDR) protocols, such as Open NAND Flash Interface (ONFI), DDR Toggle, or other interface protocols. Processing unit 637 can be implemented in common hardware as described above. VRAM 636 stores temporary data that is required to perform the card opening process, such as variables, flags, tables, etc.

Refer to FIG. 7. An embodiment of the present invention proposes a card opening method implemented when the processing unit 612 loads and executes the code of a mass production tool. This method consists of the following steps: load the port map configuration table 160 generated by the fixed port host 210 before and contain the location information of each port in the hub 530; Compare the location information in the hardware profile with the location information in the port mapping configuration table 160 to determine whether each port in the hub 530 is connected to the solid state drive; displays a GUI on the display 570 to indicate information about whether each port in the hub 530 is connected to a solid state drive; and when one of the ports is connected to a solid state drive fails to boot, update the GUI to indicate that the solid state drive connected to the corresponding port has failed to boot. The hardware profile is provided by the operating system running on the production host 510. The details are as follows:

Step S710: Load the configuration table 160 from the storage unit 616 to the port mapping table and save it in RAM 614 for quick lookup. Port Mapping Configuration Table 160 can refer to the example in Table 1 or Table 2 (described in the following paragraphs).

Step S720: Determine if all SATA/PCIe registries for Port Mapping Configuration Table 160 exist in the Windows registry of the operating system of the Production Host 510. If so, the process continues with the processing of step S730. Otherwise, it means that the software and hardware settings of the training host 210 that was used to generate the port map configuration table 160 are not the same or do not match the production host 510, and the process ends.

In detail, for each SATA registry in the port mapping configuration table 160, processing unit 612 can execute the Microsoft API function “CreateFile” to obtain the handle code of the path “Enum\PCI” in the window registry. The processing unit 612 executes the Microsoft API function “DeviceIOControl” to obtain all subkeys in the handle. Then, for each subkey, referring to the technical content described in step S420, processing unit 612 can execute the Microsoft API functions “WINSETUPAPI SetupDiGetClassDevs”, “WINSETUPAPI SetupDiEnumDeviceInterface” and “WINSETUPAPI SetupDiGetDeviceInterfaceDetail” to check if the same SATA registry exists. When any of the SATA registries in the port map configuration table 160 are not found within all the subkeys in this handle, it means that the hardware and software settings of the training host 210 that was used to generate the port map configuration table 160 are not the same or do not match the production host 510.

In addition, for each PCIe registry in the port mapping configuration table 160, the processing unit 612 can execute the Microsoft API function “CreateFile” to obtain the handle code of the path “Enum\ACPI” in the window registry. The processing unit 612 executes the Microsoft API function “DeviceIOControl” to obtain all subkeys in the handle. Then, for each subkey, referring to the technical content described in step S420, processing unit 612 can execute the Microsoft API functions “WINSETUPAPI SetupDiGetClassDevs”, “WINSETUPAPI SetupDiEnumDeviceInterface” and “WINSETUPAPI SetupDiGetDeviceInterfaceDetail” to check if the same PCIe registry exists. When any of the PCIe registry files in the port map configuration table 160 are not found among all the subkeys in this handle, it means that the hardware and software settings of the training host 210 that was once used to generate the port map configuration table 160 are not the same or do not match the production host 510.

Step S730: Scan the SSD connected to the production host. For example, referring to the technical content of steps S420 and S430, processing unit 612 can run Microsoft API functions “CreateFile”, “DeviceIOControl”, “WINSETUPAPI SetupDiGetClassDevs”, “WINSETUPAPI SetupDiEnumDeviceInterface” and “WINSETUPAPI” SetupDiGetDeviceInterfaceDetail” to obtain the location information of all SCSI devices and IDE devices connected to the production host 510. The processing unit 612 then compares the location information of all connected SCSI devices and IDE devices with all the position information in the port mapping configuration table 160 to determine which ports on the production host 510 have been connected to the solid state drive 550, and displays the detected connection results on the graphical user interface (GUI) of the display 570. For example, the GUI displays whether a solid state drive is connected on each port, the location information of each port, and the activation status of the SSD connected on each port.

In some embodiments, the processing unit 612 may display on the GUI the contents of the location information of the ports on the hub to which the solid state drive 550 is connected, for example, a bus number, an object identifier, a logical cell number, or any combination of or above.

In other embodiments, the processing unit 612 can calculate the port number based on the bus number and target identifier of a specific port, and use the port number to represent the location information of a specific port, the formula of the example is as follows: PN=BusN*MAX_PCI_TARGET_NUM+TargetID, where PN represents the port number of a specific port, BusN represents the bus number of a specific port, and TargetID represents the target identifier of a specific port, MAX_PCI_TARGET is a constant, set to an integer greater than 0, for example, 48. Table 2 shows the location information calculated based on the port mapping configuration table 160 in Table 1:

TABLE 2

| port | port number | SATA/PCIe registry |
|---|---|---|
| Port#1 | 2 | ACPI\PNP0A08\0 |
| Port#2 | 4 | ACPI\PNP0A08\0 |
| Port#3 | 6 | ACPI\PNP0A08\0 |
| Port#4 | 8 | ACPI\PNP0A08\0 |

Suppose that the SSD 550-1 to 550-4 are connected to ports 532-1 to 532-4 of the upper hub 530, respectively: Referring to FIG. 8, message boxes 810 #1 to 810 #4 in the graphical user interface 800 display the port number (as shown in Table 2) and the card opening status of port P #1 to port P #4, respectively. Squares 810 #5 through 810 #16 of the graphical user interface 800 are represented by backslashes to represent ports P #5 to ports P #16, and no solid-state drives are connected.

It should be noted here that if only the window registry is searched without providing the port mapping configuration table 160 as described in the embodiment of the present invention, only the location information of the upper port of the hub to which all solid-state drives are connected can be obtained. In other words, the production host does not know the total number of ports the hub contains, and there is no sequential relationship between the location information retrieved from the window registry that can be referenced. Therefore, even if all the location information is obtained, it cannot be associated with the physical arrangement of ports on the hub.

Step S740: Set the variable i=1. Variable i is used to record the sequence number of card opening.

Step S750: Open the card for the SSD connected to the ith port.

For example, in the card opening process, the processing unit 637 can load and execute code from read-only memory (ROM) 638 (also known as vendor command processing code) for processing vendor commands issued from production host 110. In order to respond to the initialization device command issued from the production host 510, when the processing unit 637 executes the vendor command processing code, it can perform a series of tests on the flash memory module 650 through the flash memory interface 634 to find out bad blocks, bad columns, etc., and generate bad block tables, bad line tables, etc. accordingly. The vendor command processing code can calculate the length of each entity page based on parameters such as the number of detected bad lines, and can be used to store the Error Check and Correction (ECC Code). The vendor command processing code calculates the start position of each segment in each entity page based on information such as the bad line table and ECC length, and generates a segment start table based on it. The vendor command processing code can calculate the number of Logical Address Blocks (LBA quantity) that the flash memory module 250 can store based on the number of bad blocks, the number of bad lines, the length of ECC, etc. The supplier command processing code can store the above data tables, variables, and other information in VRAM 636, and reply to the production host 510 through the driver host interface 632 to the production host 510 for notification of mass production tools. The production tool displays the initialization completion message on the display 570 to prompt the operator or engineer.

After the mass production tool receives a message from the solid-state drive 650 that the initialization is completed, it may include information such as the number of LBAs that the flash memory module 650 can store, and issue a DOWNLOAD INFO vendor command to the flash memory device 650 to instruct the solid-state drive 650 to store the initialization result in a non-volatile storage space, such as a flash memory module 650. In order to respond to the download information command, the processing unit 637 can write the data tables, variables, and other information stored in VRAM 636 to the system block of the flash memory module 650 through the flash memory interface 634 when executing the vendor command processing code. Personnel in the technical field understand that the data tables, variables, and other information generated above are the reference information required for future execution of in-system programming (ISP code, also known as firmware). The in-system code contains operations used to execute host commands issued from the host, such as host read, write, erase commands, etc. Host commands are commands regulated by standards development organizations, such as UFS, NVMe, Open-channel SSD commands, etc. The supplier command processing code can reply to the production host 510 through the driver host interface 632 to the production host 510 for notification of mass production tools. The production tool displays a message of completion of the card opening on the display 570 to prompt the operator or engineer. For example, change the status of one of the message boxes 810 #1 to 810 #4 shown in FIG. 8 to “Completed”.

However, the SSD 550 may fail on an operation in the card opening process as described above, and the processing unit 637 can reply to the production host 510 with the appropriate error code or error message via the driver host interface 632 for the production tool to display the error code or error message on the display 570 for prompting the operator or engineer. The production tool, operator, or engineer can then perform error troubleshooting operations on the SSD connected to port i.

Step S760: Determine whether the card is successful based on the reply message of the SSD 550 connected on the ith port. If so, the process continues with the processing of step S780. Otherwise, the process continues with the processing of step S770.

Step S770: Display the message on the GUI that the SSD boot failed on the ith port. Suppose the SSD 550-3 fails during the card activation process: Referring to FIG. 9, the boot status of the message box 810 #3 display port P #3 in the graphical user interface 800 is “Failed”.

Step S780: Determine whether all solid-state drives are cardged in. If yes, the process ends. Otherwise, the process continues with the processing of step S790.

Step S790: Calculate i=i+1.

By comparing the hardware profile provided by the operating system running in the port map configuration table 160 as described above and the operating system running in the production host 510, it is possible to identify whether each port on each hub in the production system 50 is connected to the solid state drive. In addition, when a solid-state drive fails to open a card, it can automatically identify which port the SSD connected to occurred during the card opening process.

All or part of the steps in the method described in the present invention can be implemented by computer instructions, such as drivers, firmware programs, or software programs of specific hardware. In addition, it can also be implemented in other types of programs. The personnel in the technical field may write the method of the embodiment of the present invention as a computer instruction, and will not describe it for the sake of brevity. Computer instructions implemented in accordance with the embodiment method of the present invention may be stored on appropriate computer-readable media, such as DVD, CD-ROM, USB disk, hard disk, or on a network server accessible via a network (e.g., the Internet, or other appropriate vehicle).

Although the above described components are included in FIGS. 2, 3, 5 and 6, it is not ruled out that better technical results have been achieved by using more additional components without violating the spirit of the invention. In addition, although the flow diagrams in FIG. 4 and FIG. 7 are executed in the specified order, without violating the spirit of the invention, a person familiar with this technique can modify the sequence between these steps on the premise of achieving the same effect, so the present invention is not limited to using only the order described above. In addition, a person familiar with the technique may integrate several steps into one step, or perform more steps in addition to these steps, sequentially or in parallel, and the present invention is not limited by this.

Although the present invention uses the above embodiments for illustration, it should be noted that these descriptions are not intended to limit the present invention. Rather, the invention covers modifications and similar settings that are obvious to those familiar with the craft. Therefore, the scope of the claims must be interpreted in the broadest way possible to include all obvious modifications and similar settings.

### BRIEF EXPLANATION OF THE DIAGRAM

FIG. 1 is a schematic diagram of the production stage according to an embodiment of the present invention.

FIG. 2 is a schematic diagram of a training system based on an embodiment of the present invention.

FIG. 3 is a block diagram of a fixed-port host and a training solid state drive according to an embodiment of the present invention.

FIG. 4 is a flow diagram of the fixed port method according to the embodiment of the present invention.

FIG. 5 is a schematic diagram of the production system according to the embodiment of the present invention.

FIG. 6 is a block diagram of a production host and a solid state drive according to an embodiment of the present invention.

FIG. 7 is a flow diagram of the card opening method according to the embodiment of the present invention.

FIG. 8 and FIG. 9 are schematic diagrams of the graphical user interface based on the embodiments of the present invention.

1. A method of producing solid state drives, executed by a processing unit of a production host, wherein the production host contains a device interface, the device interface contains a plurality of first ports, each of which connects to a hub, and each hub contains a plurality of second ports, the above method includes: loading a port mapping configuration table containing location information representing each of the above second ports; Compare the location information in a hardware profile with the location information in the port mapping configuration table to determine whether each second port is connected to a solid state drive, where the hardware profile is provided by an operating system running on the production host; displays a graphical user interface on a display that indicates whether each of the above second ports is connected to the SSD; and When one of the above second ports connects to the SSD fails to boot, update the above graphical user interface to indicate that the SSD connected to the corresponding second port above has failed to boot.

2. The method of producing a solid state drive as described in claim 1, wherein the order of the location information in the port mapping configuration table matches the default physical arrangement of the said second port of the said hub.

3. The method of producing a solid-state drive as described in claim 1, wherein the said operating system is a window operating system, and the hardware profile file is a window registry.

4. The method of producing a solid state drive as in claim 3, wherein the port mapping configuration table comprises a plurality of registries associated with the first port, and the method comprises: determining whether all registries in the port mapping configuration table exist in the window registry file; When all the registries in the above port mapping configuration table exist in the above window registry, compare the location information in the above hardware profile with the location information in the above port mapping configuration table to determine whether each of the above second ports is connected to the solid state drive; and Terminate the opening operation of the SSD when any of the above registries in the above port mapping configuration table do not exist in the above window registry.

5. The method of producing a solid state drive as in claim 1, wherein the graphical user interface displays the contents of the location information of the second port to which the solid state drive is connected.

6. The method of producing a solid state drive as claim 1, wherein the graphical user interface displays the port number of the second port to which the solid state drive is connected, and the port number is calculated using the following formula: PN=BusN*MAX_PCI_TARGET_NUM+TargetID PN represents the port number of a specific second port, BusN represents the bus number of the specified second port, TargetID represents the target identifier of the specified second port, and MAX_PCI_TARGET is a constant, set to an integer greater than 0.

7. A computer program product containing code for the production of a solid-state drive, wherein when a processing unit of a production host executes the above code, the method for producing a solid-state drive as described in claims 1 to 6 is implemented.

8. A device for the production of solid-state drives, comprising: a device interface containing multiple first ports, wherein each of the above first ports is connected to a hub, and each of the above hubs contains multiple second ports; and a processing unit, coupled to the above device interface, for loading a port map configuration table from one storage unit, containing location information representing each of the above second ports; Compare the location information in a hardware profile with the location information in the port mapping configuration table to determine whether each second port is connected to a solid state drive, where the hardware profile is provided by an operating system running on the above device; displays a graphical user interface on a display that indicates whether each of the above second ports is connected to the SSD; and when one of the above second ports connected to the SSD fails to boot, the above graphical user interface is updated to indicate the information that the SSD connected to the corresponding second port has failed to boot.

9. The device of claim 8 for the production of solid state drives, wherein the order of the location information in the port mapping configuration table matches the default physical arrangement of the second port of the said hub.

10. The device for producing solid-state drives as described in claim 8, wherein the operating system is a window operating system, and the hardware profile is a window registry.

11. The device of claim 10 for the production of solid-state drives, wherein the port mapping configuration table comprises multiple registries associated with the first port, and the processing unit used to determine whether all registries in the port mapping configuration table exist in the window registry; When all the registries in the above port mapping configuration table exist in the above window registry, compare the location information in the above hardware profile with the location information in the above port mapping configuration table to determine whether each of the above second ports is connected to the solid state drive; And when any of the above registries in the above port mapping configuration table do not exist in the above window registry, the opening operation of the SSD is terminated.

12. The device for producing the solid state drive according to claim 8, wherein the graphical user interface displays the contents of the location information of the second port to which the solid state drive is connected.

13. The device for the production of solid state drives as of claim 8, wherein the graphical user interface displays the port number of the second port to which the solid state drive is connected, and the port number is calculated using the following formula: PN=BusN*MAX_PCI_TARGET_NUM+TargetID PN represents the port number of a specific second port, BusN represents the bus number of the specified second port, TargetID represents the target identifier of the specified second port, and MAX_PCI_TARGET is a constant, set to an integer greater than 0.
